(19) United States
(12) Patent Application Publication
(10) Pub. No.: US 2006/0021777 A1
(43) Pub. Date: Feb. 2, 2006

(54) Raceway adapter

(76) Inventor: James W. Williams, Branchburg, NJ (US)

Correspondence Address: B2 PATENT SERVICES, 406 ROSEMONT-RINGOES ROAD, STOCKTON, NJ, 08559, US

(21) Appl. No.: 10/901,516

(22) Filed: Jul. 29, 2004

(51) Int. Cl. H01H 23/04

(52) U.S. Cl. 174/54

(57) ABSTRACT

This invention relates to a raceway adapter for use in connecting electrical, electronic, security and various telecommunications cabling and wiring conduit to surface mount outlet boxes. The raceway adapter is able to securely connect raceways to outlet box openings of varying size and shape. This creates compatibility between otherwise non-fitting raceways and outlet boxes of more than one commercially available brand.

### BACKGROUND OF THE INVENTION

Standard electrical outlet and junction boxes used in residential and commercial installations are commonly of rigid, molded plastic or metal construction. Raceways for surface mounted wiring and cabling to these boxes can vary in size, color and shape, dependent upon the manufacturer. Convenient interconnection of brands is not possible because of these differences in design, making installation of new construction, remodeling or upgrading interior decor difficult or impossible. Additionally, electricians and security wiring technicians need to carry complete sets and duplicate parts for the variety of raceways they may encounter. There exists a need in the trades for a device which would overcome these variations and would limit the number of parts and equipment an installer needs to bring to the job site.

### SUMMARY OF THE INVENTION

The subject of this invention is a raceway adapter used in electrical, electronic, security, telecommunications and related fields for installation of wiring and cable from a surface mounted raceway along a wall to a surface mounted outlet or junction box. The raceway adapter is a plastic clip which fits over and locks on one end to the raceway and possesses a channel edge on the other end which engages the knockout opening of the outlet box, locking the raceway into position. The raceway adapter is able to securely connect raceways to outlet box openings of varying size and shape.

This creates compatibility between otherwise non-fitting raceways and outlet boxes because of difference in size or shape, allowing the use or connection of more than one commercially available brand of raceway and outlet box. In addition, the raceway adapter is able to slide along the end of the raceway, allowing end length adjustment of the raceway at the outlet box opening for easier installation.

The Underwriters Laboratory requires that surface mounted outlet boxes be connected to the corresponding raceway to provide a secure connection that can not be removed without destroying the connection and that an object such as a screwdriver tip or knife blade can not be inserted into the box and accidentally cut the wires.

### DETAILED DESCRIPTION OF THE INVENTION

For the purposes of this invention, a raceway is defined as a hollow conduit used for conducting, protecting and hiding cables and wiring along interior walls. For the purposes of this application a raceway is surface mounted and made of plastic. It is securely mounted to the surface of a wall by means of screws, nails or double-sided adhesive tape. Once in place, a raceway can be threaded with electrical wire or wires. Electrical wires are defined for the purposes of this invention as being any coated wire use to carry electrical, electronic, telecommunication, security or computer signals.

The design of a raceway is such that removal of the threaded wires after installation will cause destruction of the raceway.

For the purposes of this invention, an outlet box is a plastic or metal, lidless rectangular box with four sides and a back which serves as an intersecting point for electrical wires. Commonly available types of outlet boxes are single boxes, measuring approximately 2½″ by 4″, double boxes, measuring approximately 4″ by 4″ and gang boxes, which are constructed by placing single boxes side-by-side. The type of outlet box used depends upon the number and size of incoming and outgoing electrical wires and varies with each construction project.

An outlet box is securely mounted to the surface of a wall by means of screws, nails or double-sided adhesive tape. Once in place, raceways conducting electrical wires are inserted into one of the four sides of the outlet box through openings called knockout holes. As defined herein, a knockout hole is an opening in a side of an outlet box created by removal of a previously perforated, folded or otherwise weakened portion of the box designed for such removal. Knockout holes vary in shape and size from rectangular to square to circular and from approximately ½″ to 2½″ in width, depending upon the commercial brand.

Once the raceways are securely connected to the outlet box, the electrical wires can be joined within the confines of the outlet box according to the specifications of the job.

This invention describes a raceway adapter which is a “U” shaped piece of molded plastic, one end of which clips over an electrical raceway. The other adapter end contains a channeled edge perpendicular to the raceway which inserts through and fits securely into a knockout hole of an outlet box.

The raceway adapter may vary in width from ½″ to 1½″ at the channeled edge end in order to fit securely into knockout holes of various outlet boxes currently available on the market. Brand names of outlet boxes include, but are not limited to, Leviton©, Panduit©, WireMold©, ICC© and Superior Modular©. The adapter end which clips over a raceway may vary in width from ½″ to 1½″ to fit an assortment of raceway sizes. Both ends of the adapter need not be the same width. The channeled edge end of the adapter may be smaller or larger in width than the end which clips over a raceway in order to accommodate smaller and larger sized knockout holes of various outlet boxes.

The raceway adapter may be made of UL© rated plastic, metal or coated metal but is not limited to these materials. In an embodiment of this invention, the adapter is movable when clipped over a raceway, sliding along the raceway until it meets and fits into a knockout hole of an outlet box. This sliding feature allows extension of the raceway length during installation. The extension length may range from ¼″ to 3″ but is not limited to this length. One skilled in the art would recognize that virtually any type of wiring or cable application that commonly uses a raceway and outlet box can be used with the device described herein. This includes but is not limited to telecommunications, electrical, electronic, security and computer wiring systems.

In one embodiment of this invention the raceway adapter will form a junction with the outlet box at the knockout hole such that an object (e.g. screwdriver tip or knife blade) cannot be inserted (either accidentally or purposefully) into the box through this junction. In another embodiment, the raceway adapter cannot be removed from the wall mounted outlet box once installed without first removing the outlet box from the wall.

### EXAMPLES

The raceway adapter can be used for the installation of computer cable in a residence or commercial building. The cable would be conducted through an appropriately sized raceway along a wall or base board and end at a surface mount outlet box. The raceway could be joined to the outlet box using the raceway adapter in the following manner: the raceway adapter would be clipped over the end of the raceway, adjusted to perfect length by sliding and then secured to the outlet box by fitting together the channeled edge end of the adapter and the knockout box opening of matching size and shape. The outlet box could be fitted with a face plate into which a personal workstation could be plugged. One skilled in the art would recognize that this example is non-limiting and that use of this invention across a large number of trades is possible.

What is claimed:

1. A device for connecting raceways to surface mounted outlet boxes.

2. The device of claim 1 wherein the device is made of UL© rated plastic.

3. The device of claim 1 in which the device is made of coated metal.

4. The device of claim 1 wherein the device is “U” shaped and has a first and second end.

5. The device of claim 4 wherein said first end clips over a raceway.

6. The device of claim 5 wherein said first end slides on the raceway to allow adjustment of a length.

7. The device of claim 6 in which said second end has a channeled edge perpendicular to the raceway.

8. The device of claim 7 in which the channeled edge fits securely into a knockout hole of an outlet box.

9. The device of claim 8 in which the channeled edge end measures ½″ in width.

10. The device of claim 8 in which the channeled edge end measures 1″ in width.

11. The device of claim 8 in which the channeled edge end measures 1½″ in width.

12. The device of claim 8 in which the channeled edge end fits into a Panduit© brand outlet box.

13. The device of claim 8 in which the channeled edge end fits into a Leviton© brand outlet box.

14. The device of claim 8 in which the channeled edge fits into a WireMold© brand outlet box.

15. The device of claim 8 in which the channeled edge end fits into an ICC© brand outlet box.

16. The device of claim 8 in which the channeled edge fits into a Superior Modular© brand outlet box.

17. A method for connecting an outlet box to a raceway by,
attaching the raceway to the surface of a wall,
attaching an adapter to the raceway,
attaching the outlet box to the adapter and
attaching the outlet box to the wall.

18. The method of claim 17 wherein the outlet box is Panduit© brand.

19. The method of claim 17 wherein the outlet box is Leviton© Brand.

20. The method of claim 17 wherein the outlet box is WireMold© brand.

21. The method of claim 17 wherein the outlet box is ICC© Brand.

22. The method of claim 17 wherein the outlet box is Superior Modular© Brand.
